(19) United States
(12) Patent Application Publication
(10) Pub. No.: US 2026/0245469 A1
(43) Pub. Date: Aug. 20, 2026

(54) MULTI-MODEL AUGMENTED-REALITY INSTRUCTIONS FOR ASSEMBLY

(71) Applicant: The Texas A&M University System, College Station, TX (US)

(72) Inventors: Wei Yan, College Station, TX (US); Seda Tuzun Canadinc, Bryan, TX (US)

(21) Appl. No.: 19/489,517

(22) PCT Filed: Jun. 2, 2024
(86) PCT No.: PCT/US2024/032165

§ 371 Date: Dec. 2, 2025

Related U.S. Application Data
(60) Provisional application No. 63/506,007, filed on Jun. 2, 2023.

(51) Int. Cl. G09B 5/02; G06T 7/73; G06T 19/00; G06T 19/20; G06V 10/774; G06V 20/20

(52) U.S. Cl. CPC G09B 5/02; G06T 7/75; G06T 19/006; G06T 19/20; G06T 2219/2008; G06T 2219/2016; G06V 10/774; G06V 20/20

(57) ABSTRACT

Augmented-reality (AR) instructions for assembly of a physical object may be based on an assembly sequence divided into multiple assembly phases, using separate computational three-dimensional (3D) registration models (e.g., object recognition models) for the different phases. A user may be guided step by step through the assembly sequence, using a step counter to keep track of where in the assembly sequence the user is. In each step, an AR image may be created by rendering, overlaid onto the camera image, a virtual model of a part of the physical object to be added during the step, spatially registered with the physical object in its partially assembled state.

### CROSS-REFERENCE TO RELATED APPLICATION

This application claims priority to and the benefit of U.S. Provisional Application Ser. No. 63/506,007, filed on Jun. 2, 2023, which is hereby incorporated herein by reference in its entirety.

### BACKGROUND

Augmented-reality (AR)-assisted assembly has emerged as a user-friendly approach to guiding an individual or group of people step by step through the assembly of a physical object (e.g., a construction toy, piece of furniture, building, etc.), providing an alternative to conventional instruction manuals and booklets. AR can not only present virtual objects in a physical environment, e.g., overlaid onto a camera view, but also align (or “register”) the virtual objects to the physical objects in real-time. This capability allows generating interactive, immersive visual assembly instructions that show the next part to be added, at a given point in the assembly process, as a virtual object in correct spatial relation to the image of the partial physical assembly. By bridging the gap between the virtual world and the physical world in this manner, AR-based assembly instructions have the potential to alleviate some of the cognitive load associated with traditional printed instructions, which require a frequent switch in focus between the instructions and the physical objects. In addition, AR allows virtual objects to be rotated and viewed from arbitrary angles, a capability that printed instructions lack.

To achieve high precision and accuracy in spatially registering virtual and physical parts in the AR display, current AR-based assembly instructions often use markers. However, the use of markers is not practical in all use cases and can, in some instances, compromise the appearance of the physical object and/or spoil the immersive experience. Further, to avoid loss of registration, care must be taken to prevent the marker from moving out of the camera view or becoming obstructed by the physical object, which imposes limitations on the user's interactions with and movements of the physical object. But if users cannot freely handle the physical object, e.g., if they miss out on back views of the object, AR is not used to its full potential. The restrictions on movements of the physical object can be severe. For instance, marker use may require a physical assembly to stay on a surface even if it would be possible to detach it from the surface while handling and rotating it in hand during the assembly process. Also, sometimes, the markers and physical assembly are separated by the user, undermining the registration and causing misalignment.

On the other hand, current marker-less AR options likewise suffer from various difficulties, in particular with tracking physical parts and registering virtual parts in the AR display with high precision, especially if the view of a part is blocked or hidden from the camera during the assembly. GPS-based object registration, for instance, does not work well inside buildings and is unsuitable for small-scale precision.

### BRIEF DESCRIPTION OF THE DRAWINGS

Disclosed herein is an approach to AR-assisted assembly that addresses some of the aforementioned problems with marker-less, model-based registration between physical and virtual objects. Various embodiments are described with reference to the following drawings.

FIG. 1 is a block diagram of a system for providing AR instructions for the assembly of a physical object, in accordance with various embodiments.

FIG. 2 is a schematic user interface showing an example AR display of a virtual assembly model overlaid onto a camera image of a partial physical assembly to provide instructions for the next assembly step, in accordance with various embodiments.

FIG. 3 is a flowchart of a method of providing AR instructions for the assembly of a physical object, in accordance with various embodiments.

FIG. 4 is a flowchart of a method of creating a software application providing AR instructions for the assembly of a physical object.

FIGS. 5A-5D are schematics of virtual assembly models for four phases in the assembly of a physical brick model.

FIG. 6 is a block diagram of an example machine upon which any one or more of the techniques (e.g., methodologies) discussed herein may perform.

### DESCRIPTION

Described herein are devices, systems, methods, and software applications that provide step-by-step, in-situ three-dimensional (3D) AR instructions for the assembly of physical objects, utilizing marker-less, model-based registration between physical and virtual objects. In model-based registration, a computational model of a physical object is employed to automatically recognize and localize the object in a camera image, enabling virtual objects to be superimposed onto the image in proper alignment with the physical object. For example, in AR-assisted assembly, a 3D computational model of the partially assembled physical object, hereinafter also called an “object recognition model” or “registration model” for the physical object in its partially assembled state (also the “partial physical assembly”), can be used to determine the location and orientation of the physical object within the camera view, and the virtual part for the next assembly step can then be rendered in the image to indicate its intended place. After completion of this assembly step, however, the now modified physical object no longer matches the object recognition model, which, over the course of successive assembly steps, will result in continual degradation, and eventually loss, of registration. Using a separate object recognition model for each step in the assembly, on the other hand, also faces challenges. For one thing, generating separate object recognition models for all individual steps is computationally expensive; for physical assemblies with large numbers of parts (e.g., in the hundreds or thousands), the computational cost can become practically prohibitive. In addition, some parts of the physical assembly being obstructed by other parts due to the geometry of the physical assembly can become a hurdle for object recognition.

In accordance with various embodiments, these challenges are addressed with a multi-model-based registration approach: instead of using a single object recognition model throughout the assembly process, or conversely, using separate object recognition models for all individual steps, the assembly process is divided into multiple phases each generally including multiple steps (although in exceptional cases, single-step phases may also be included), and a separate object recognition model is generated and utilized for each phase. Since object recognition has some tolerance to changes in the physical object, registration of the physical object can generally be maintained for several steps with a single model. The number of phases, and the steps that demarcate them, may be selected, e.g., based on straightforward empirical testing and/or heuristics, to ensure that registration is not lost within any given phase or at any step. In some embodiments, the phases are significantly smaller in number than the steps. For example, an assembly sequence with hundreds of steps may be divided, in some cases, into fewer than ten phases.

While object recognition models created for multi-step phases can avoid the pitfalls of both a single model for the entire process and many step-specific models, and achieve good registration between physical and virtual assemblies at low or moderate computational cost, they do not by themselves allow tracking the steps of the assembly process. To provide this functionality and facilitate step-by-step instructions, a step counter, either manual or automatic, is employed in various embodiments. After the physical and virtual partial assemblies have been registered at the beginning of a phase, additional virtual parts are rendered for one step at a time (where a single step may include the addition of multiple parts), and after each step, the step counter is incremented in response to receipt of an indication that the step was completed. In the case of a manual counter, the user may indicate completion of the step via a suitable input device (e.g., by pushing a button on screen). In the case of an automatic counter, a computer vision or artificial intelligence (AI) system can automatically detect that the step has been completed, e.g., based on an image difference between current and previous images that indicates addition of a part. Throughout this process, movements of the physical object are tracked with the object recognition model for the current phase, and the virtual object rendition is updated accordingly. When the step counter reaches the end of the phase, object recognition transitions to the object recognition model for the next phase. This process enables a flexible and accurate AR registration for physical object assembly, and has been shown to work well even for small parts.

Multi-3D-model-based AR instructions for assembly as disclosed herein have a wide range of potential applications across industries including construction toys, furniture, manufacturing, building construction, DIY repairing, training, educational services, etc. Compared to prior AR instruction methods used in assembly (such as the marker-based AR instructions), the present approach allows AR instructions to be significantly easier to use for many different assembly scenarios, including hand-held assembly, when markers are not convenient or available, or when 3D-model-based AR registration is necessary, but the physical assembly updates step by step. The AR instructions can assist both human users and robots with computer vision capabilities with assembling physical objects.

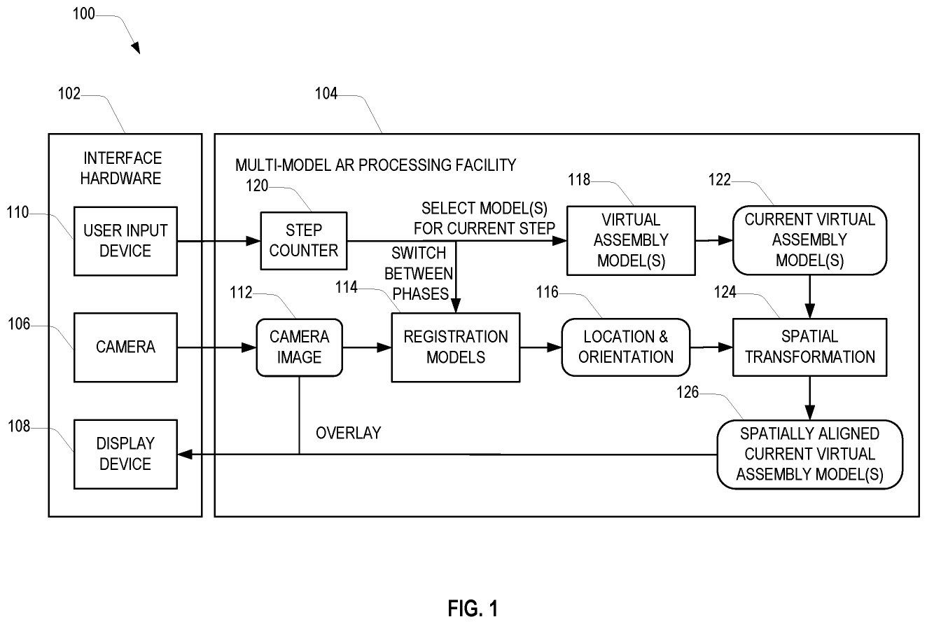

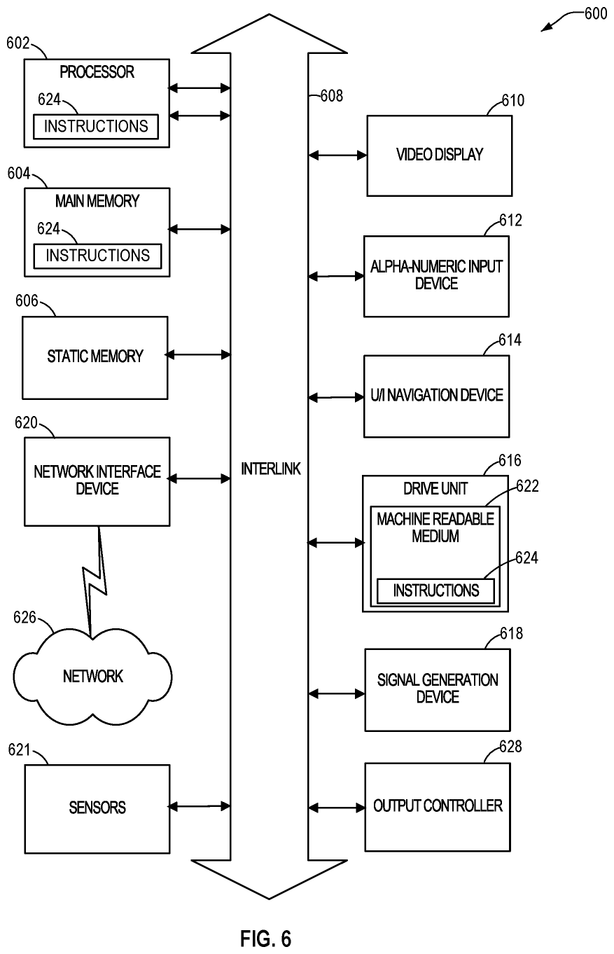

Turning now to the drawings, FIG. 1 is a block diagram of a system 100 for providing AR instructions for the assembly of a physical object, in accordance with various embodiments. The system 100 includes interface hardware 102, as well as a multi-model AR processing facility 104 implemented by a suitable combination of computing hardware and software, such as a general-purpose processor executing program code stored in computer memory, or one or more special-purpose processors (e.g., digital signal processors, field-programmable gate arrays, etc.). The interface hardware 102 includes a digital camera 106, a display device 108, and one or more user input devices 110 (e.g., keyboard/mouse, audio input, etc.). In some embodiments, the display device 108 is a touchscreen that doubles as the user input device 110. The system 100 may be implemented by a single device, such as a smartphone, smart tablet, or laptop with an integrated camera or a standalone AR headset (e.g., Hololens®, Magic Leap®, Apple Vision Pro, Meta Quest, etc.), or by multiple devices, like a desktop computer connected to a camera or to AR goggles. Suitable computing devices for implementing the system 100 are explained in more detail below with reference to FIG. 6.

The camera 106 may be used to capture video of the step-wise assembly of a physical object, with individual video frames, or camera images 112, generally showing the object in a partially (or, at the end, fully) assembled state (except for the initial images of the scene prior to start of the assembly process). For hands-free video acquisition, the camera 106, or device including the camera (such as a smartphone), may be mounted on a tripod or other holder at a fixed location. Alternatively, in the case of AR goggles or similar wearable devices, the camera 106 is worn by the user.

The processing facility 104 includes various computational components for processing the camera images 112 and generating visual AR assembly instructions for display to the user on the display device 108. A set of registration models 114 for multiple assembly phases is used to determine the 3D location and orientation 116 of the (partial) physical assembly in the camera images 112. The registration models 114 may include a ground plane detection model to register a physical surface at the beginning of the process, before any part has been placed, to be used in the first phase of the assembly process, and multiple object recognition models to detect progressively large partial assemblies for the subsequent assembly phases. Alternatively to ground plane detection, the first phase may utilize an object recognition model for the first part or the first few parts of the assembly, but for some physical objects or applications, that does not provide for robust registration, rendering the ground plane detection preferable in these cases. The registration models 114 may be machine-learning models, e.g., deep neural networks, trained based on images (real or virtual) of the physical assembly during a given phase.

The computational components further include a set of virtual assembly models 118, which are digital visual models of the physical assembly intended for rendering on the display device 108. The virtual assembly models 118 may include CAD (computer-aided design) models of the physical assembly, and may come with various different visual properties. In some embodiments, the virtual assembly models 118 include a wireframe model that shows the edges of the assembly, a rendered model (or “surface model”) that appears like a solid object, and a phantom rendered model (or “transparent occlusion model”) that serves to more realistically represent occlusion. In AR image displays, virtual objects are generally placed on top of the images of the physical scene, and therefore, virtual parts do not by default appear occluded by any physical parts in front of them. To create the illusion of occlusion, another virtual layer may be added to the AR display, representing the physical parts in the front by a phantom rendered (that is, transparent or see-through) virtual model. The virtual assembly models 118 may be models of the full physical assembly, but composed of parts that can be individually turned on or off to represent the partial assemblies for the different steps in the assembly process. Alternatively, the virtual models 118 may include separate models for the partial assemblies at the various assembly steps.

To keep track of the current step in the assembly process, the computational models include a step counter 120, which is incremented (or decremented) responsive to user input via the user input device 110, or responsive to automatic detection of the completion of the step. In some embodiments, “next” and “previous” buttons are displayed in the user interface on the display device 108, allowing the user to step through the assembly forwards or backwards by pressing (touching) or clicking these buttons. In other embodiments, this functionality is provided by physical buttons, keys, clickers, or similar user input elements, such as left and right arrow keys on a keyboard, up and down buttons on a smartphone, or custom clickers or foot pedals connected to the computer. Yet another option is to control the step counter 120 based on voice input via a microphone. Other user input modalities for incrementing the step counter 120 will occur to those of ordinary skill in the art. The step counter 120 serves to determine the current phase in the assembly process and select the corresponding one of the phase-specific registration models 114, causing registration models 114 to switch between the last step of one phase and the first step of the next. Further, based on the step count, the virtual assembly models are configured for the current step (e.g., by turning on only the parts assembled during preceding steps, or only the next part to be added, depending on the selected rendering options), or the virtual assembly models for the current step are selected among a set of step-specific models, as the case may be.

The current virtual assembly model(s) 122, as configured or selected responsive to the step counter 120, are spatially transformed, by a spatial transformation module 124, based on the location and orientation 116 of the physical model in the camera image 112 to align them with the physical assembly in the camera image 112. The spatially aligned current virtual assembly model(s) 126 may then be overlaid onto the camera image 112 to create an AR display for rendering on the display device 108. Alternatively, if an AR device with an optical-see-through display is used (e.g., HoloLens), the virtual assembly model(s) 126 may be displayed on the optical-see-through display “overlaid onto” and aligned with the real physical environment as seen through the display (which, in turn, comports with the image as acquired by the camera). Accordingly, it is to be understood that, where the description refers to a “camera image” in the context of the AR display, the camera image can generally be substituted with a view of the physical environment, e.g., in an optical-see-through AR device.

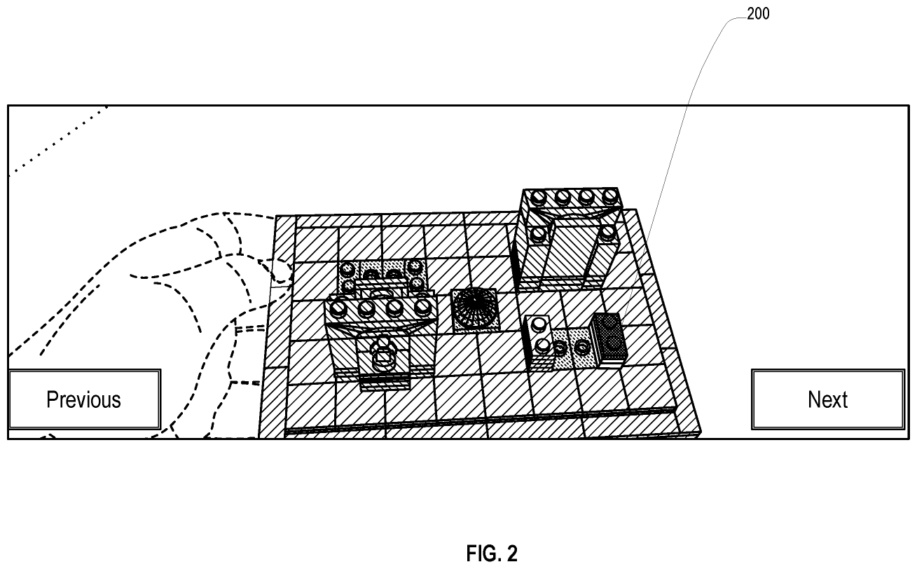

FIG. 2 is a schematic user interface showing an example AR display of a virtual assembly model overlaid onto a camera image of a partial physical assembly to provide instructions for the next assembly step, in accordance with various embodiments. The example shows a partially assembled brick toy (e.g., a LEGO® assembly), held in hand by the user. Overlaid onto the physical image of the physical assembly is a wireframe virtual model showing the parts of the assembly that have been added in previous step. In addition, a virtual rendered model of a part 200 to be newly added in the current step is displayed in the correct location. The AR display also includes “Previous” and “Next” buttons as explained above.

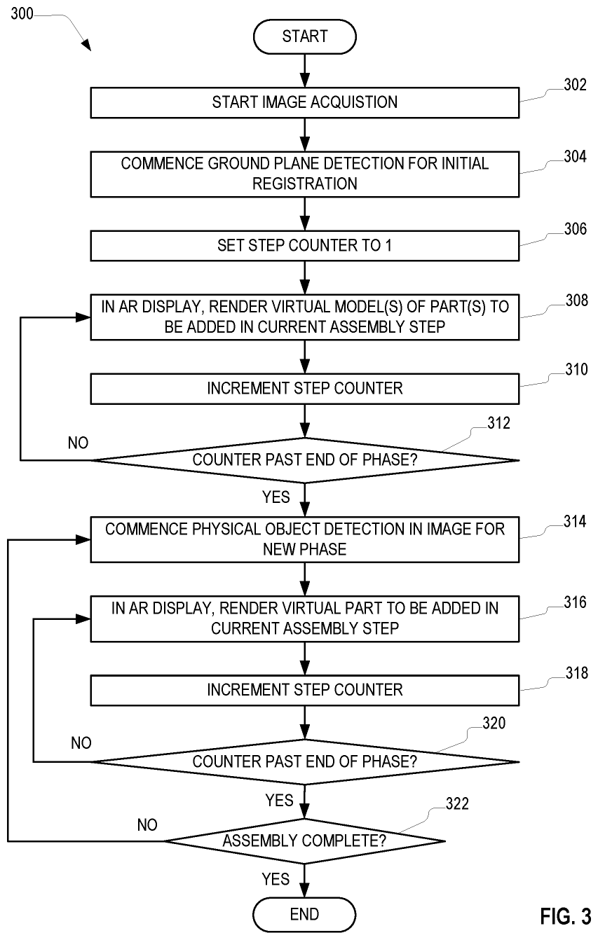

FIG. 3 is a flowchart of a method 300 of providing AR instructions for the assembly of a physical object, in accordance with various embodiments. The method 300 begins with commencing image acquisition by the camera (operation 302), followed by image registration for the first assembly phase (operation 304). Since at the beginning of the assembly process, no physical parts are assembled yet, this initial image registration may involve detecting a ground plane, that is, a flat surface visible in the image (such as a table top, floor, or wall). The virtual assembly model(s) can then be anchored at a selected location within the detected ground plane. For example, in some embodiments, the user is prompted to tap on the screen (e.g., within a region marked by a rectangle displayed on screen), and the tapped location is used as the anchor location. The step counter is set to 1 (operation 306), and then a virtual model of the part(s) to be added in the first assembly step is rendered in the AR display at the anchor location (operation 308).

Responsive to input indicating that the user has completed the first physical assembly step (e.g., hitting “next” in the user interface), the step counter is incremented (operation 310), and the virtual assembly model displayed on screen is updated for the second step, including by rendering a virtual model of the new parts to be added to the assembly (operation 308). In some embodiments, the new parts are displayed as a rendered model, whereas the parts added in the previous step (or all preceding steps in subsequent iterations) may be displayed as a wireframe model (which may selectively be turned off). Of course, other modes of rendering the previous and currently to be added parts are possible. The process continues in a loop until the last step of the first phase has been completed and the step counter has been incremented past the end of the first phase to the first step of the next phase (at 312). During the first assembly phase, the physical assembly is to remain at a fixed position and orientation relative to the ground plane. However, movements of the ground plane and physical assembly together relative to the camera are permitted and can be tracked with the ground plane detection model. This flexibility allows, for instance, viewing the assembly from different angles at different steps.

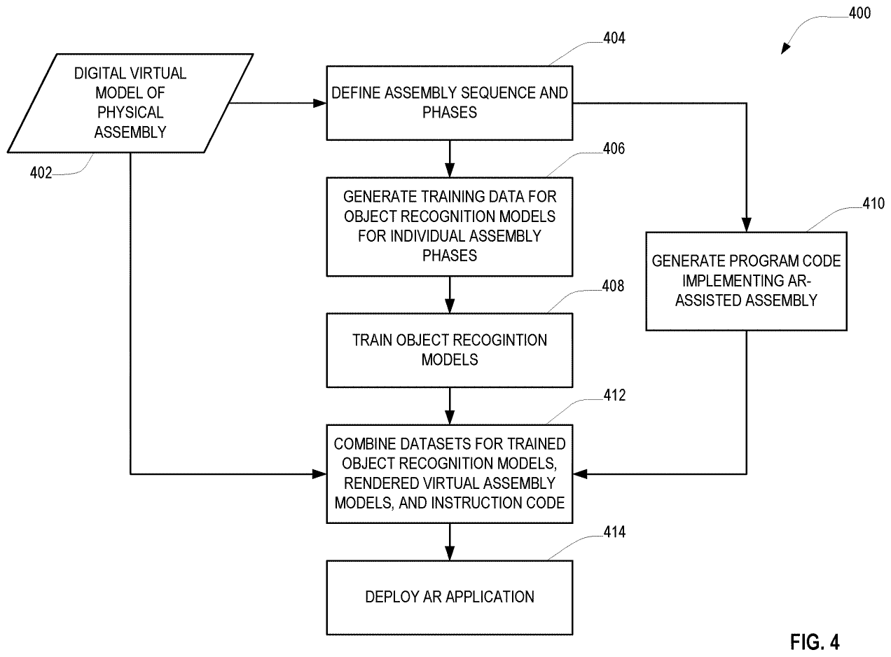

At the start of the second phase, image registration switches over from ground plane detection to physical object detection with the object recognition model for the second phase (operation 314). This object recognition model may correspond to the partial physical assembly at the beginning (e.g., before or after completion of the first step) of the second phase, or to the partial physical assembly at a later step in the second phase, as explained in more detail below with reference to FIG. 4. At each step, a rendered virtual model of the new parts to be added is displayed, optionally along with a visually different (e.g., wireframe) virtual model of the partial assembly resulting from the previous steps (operation 316). The virtual model parts are aligned with the physical assembly based on the location and orientation of the physical assembly that is output by the object recognition model. The process continues, incrementing the step counter (operation 318) at each step in response to the input from the user or AI, until the step counter has passed the last step of the second phase (at 320). The assembly instructions then proceed to the third assembly phase, and so on. At the beginning of each subsequent phase, the registration model is switched over to the corresponding object recognition model for the new phase (operation 314). During the process, the physical assembly can be freely transformed in 3D space, e.g., by a user holding and rotating the physical object in hand. The method ends when the whole assembly is complete (at 322).

Note that, while not depicted in the flowchart, the described assembly sequence can be traversed both forwards and backwards. At any given step, the step counter can be decremented in response to user or AI input, causing the virtual model from the previous step to be displayed. This capability allows the user to reverse and correct assembly steps if needed, and may also be used for disassembly of a physical object. When the assembly sequence is traversed in reverse order, the virtual part displayed in the AR image for any given step (which, in the forward direction, would indicate the part to be added) corresponds to the part to be removed at that step. Upon completion of a given assembly phase in the reverse direction, the registration model is switched from the registration model associated with the just completed phase to the registration model associated with the assembly phase that precedes it in the assembly sequence.

In certain alternative embodiments, the need for ground plane detection in the first phase is avoided by instead utilizing an object recognition model for the first part of the assembly as the registration model for the first phase. In this case, the initial registration takes place after the user, with knowledge of what the first part is, has found the first part and shown it to the camera. Utilizing an object recognition model in the first phase has the benefit of allowing free rotations of the model from the beginning. However, since the partial assembly changes more drastically from step to step in the early stage of the assembly, the object recognition model may need to be switched more frequently than in later stages.

FIG. 4 is a flowchart of a method 400 of creating a software application providing AR instructions for the assembly of a physical object. Input 402 to the method 400 is a digital virtual model, e.g., a CAD model, of the physical object (or, synonymously, the physical assembly) that specifies the geometry and sizes of all individual parts as well as their spatial relation to each other within the assembly. The virtual assembly model may also include information about surface properties of the parts, such as colors, textures, and patterns. The virtual assembly model may be used with multiple rendering modes for creating virtual assembly models with different visual properties—such as the rendered/surface model, phantom rendered model, and wireframe model described above—for display. The differently rendered models may be generated and recorded in data storage for later use, or created on the fly just prior to display. Further, virtual models of partial physical assemblies may be generated from the model of the full assembly by specifying the parts to be included. Such partial assembly models may likewise be pre-generated and stored, or created when needed.

The method 400 begins, at 404, with planning and defining the assembly sequence, that is, the order in which the parts are assembled, along with the assembly phases, that is, the grouping of assembly steps for purposes of model-based object recognition. (“Grouping” is intended to imply that at least one of the groups has multiple steps, but does not necessary mean that each assembly phase has multiple steps, although that what will usually be the case in practice.) The assembly sequence and phases are determined based on a number of criteria including, in particular, object recognition and registration accuracy and the goal to limit the number of phases and associated computational cost of training the respective object recognition models. Factors that affect registration and are to be considered in conjunction with the assembly sequence include part size, geometry, surface properties, and location within the assembly, the size ratio of a part to the overall (partial) assembly, and the total number of parts.

A significant consideration is the effect that adding individual parts has on edge detection and the overall shape of the assembly. Registration works well with geometrically complex models (which are more easily distinguished from other shapes in the environment), in particular models with complex edges, as well as asymmetrical models because they provide different edges on opposite sides of the model, which provides a sense of orientation about which side is the front, back, right, and left, and contributes to the robustness and accuracy of registering the virtual model on top of the physical model. Symmetrical models, on the other hand, may lead to confusion due to ambiguous orientations. Note, in this context, that in cases where printed instructions that define an assembly sequence are available, the AR instructions need not necessarily follow that same sequence. For physical assemblies that exhibit symmetry (e.g., architectural toy brick models or furniture), for instance, printed (e.g., booklet) instructions often organize the assembly process in a way that reflects the symmetry at multiple steps of the assembly. AR instructions may deliberately deviate from such an assembly sequence and instead order the steps in way that optimizes partial assemblies used for object recognition with asymmetrical features and edges. Also, because object recognition tends to work better on larger objects with sufficient features and details to detect, sub-assemblies that are subsequently integrated into the larger assembly, as are often used in printed instructions, may be eliminated from the assembly sequence in AR instructions, in accordance with some embodiments. Other criteria that may be considered in defining the assembly sequence include structural stability, e.g., providing a strong base for subsequent steps and assuring attachment of parts (e.g., in a physical brick model) under pushing, pulling, and holding forces; and user experience, e.g., locating a sequence of assembly steps in proximity for convenience and efficiency.

Once the assembly phases are defined, object recognition models are created for the individual phases (with the exception, in some embodiments, of the first phase, for which a ground plane detection model may be used instead). Creating an object recognition model for a given phase may involve two steps. First, training data is generated from one or more virtual assembly models associated with the phase at 406, and then the object recognition model—generally a machine-learning model such as, e.g., a deep neural network model—is trained on that data at 408. In some embodiments, the training data is created from a single virtual assembly model corresponding to the partial assembly at the beginning or end of a particular step within the phase. In other embodiments, training datasets are created from multiple virtual assembly models corresponding to multiple steps within the phase, and thereafter combined into a single training dataset.

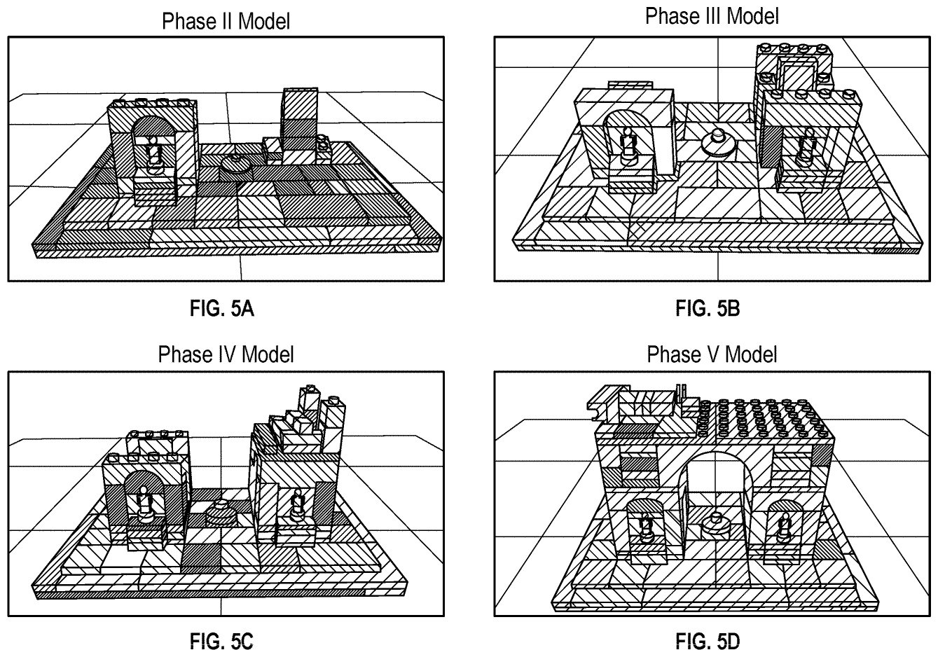

Generating a training dataset from a given virtual assembly model (e.g., of a specific partial assembly) may involve creating images (e.g., perspective views) of the virtual assembly model with different backgrounds, simulated lighting conditions, and/or different diagrammatic colorizations (as explained below with reference to FIG. 5). Further, to train the object recognition model to recognize the physical assembly from different viewing directions, generating the training dataset may involve computationally rotating the virtual assembly model to different angles (e.g., tens, hundreds, or thousands of different angles) in the polar direction and/or the azimuthal direction, and generating perspective views of the model at these angles, mimicking different camera viewing angles. The different angles may vary over the entire 2π range in the azimuthal direction, the polar direction, or both, or over a limited range of viewing angles, e.g., as specified by a user. In addition to creating perspective views from different angles, perspective views may also be created for different 3D locations of the assembly relative to a camera location by translating the virtual assembly model to different positions within the image and varying its size within the image. For each perspective view generated, a training input-output data pair is stored that includes the perspective view as the input and the corresponding known 3D location and orientation of the assembly model as the output (often referred to as the “ground-truth output” or “label”), e.g., in the form of a vector. Alternatively to creating the training data from the virtual assembly model, it is also possible to obtain the training data by acquiring images of a physical (partial) assembly of a given step from multiple different viewpoints and viewing angles, provided the location and orientation of the model relative to the camera can be measured or otherwise be known with sufficient accuracy.

The training data for each phase is used at 408 for the supervised training of the respective object recognition model for the phase. In brief, training involves using a suitable learning algorithm to iteratively determine free parameters of the machine-learning object recognition model, such as the network weights of a neural network model, to fit the training data. In supervised training, the input of a training data pair is fed into the model to generate a model output of the same type as the ground-truth output, and the difference between model and ground-truth outputs is quantified, using a loss (or “cost”) function (or objective function) that aggregates the differences over many training data pairs. Based on the computed loss, the model parameters are adjusted iteratively until a desired quality of the fit (as characterized by a loss below a certain threshold) is achieved. Suitable training algorithms are well-known to those of ordinary skill in the art. For example, neural network models can be trained by backpropagation of errors with gradient descent. In some embodiments, the object recognition model for a phase is created from datasets for multiple virtual assembly models for multiple respective steps. In this case, the object recognition model may initially be trained on the dataset of one virtual assembly model, and transfer learning can then be used to further train the (pre-trained) object recognition model on the dataset(s) for additional virtual assembly models. It is also possible to pre-train the object recognition models for the defined assembly phases, and then use transfer learning to generate a refined object recognition model for each individual step to enhance robustness in object recognition, with reduced time compared to training models for all steps individually. Combined with the use of the step counter, these step-based object recognition models can detect the completion of each step and detect errors during the assembly process.

In addition to generating the object recognition models, creating the software application includes writing, at 410, the program code that implements the workflow for AR-assisted assembly, which involves keeping track of the current step and phase with the help of the step counter, transitioning between the different object recognition models (and, if applicable, ground plane detection model), and causing the correct virtual assembly model for the current step to be selected, spatially transformed for proper registration and alignment with the physical assembly as shown in the camera images, and rendered in the AR display in the desired rendering mode. In some embodiments, the rendering modes that come with the virtual assembly model are augmented by special program code to generate, e.g., transparent virtual models for realistic object occlusion. The program code may also enhance the step-by-step visual instructions provided to the user in the form of the AR display of virtual parts overlaid onto the physical model with visual annotations (e.g., arrows pointing to the assembly location), audio information, or other features that can enhance the user experience. The program code can be written in any suitable programming language, including, e.g., in C, C++, C #, Java, Python, Fortran, Pascal, and others.

The datasets of the virtual assembly models (e.g., in various rendering modes), trained object recognition models (and, if applicable ground plane detection model), and program code that implements the workflow are combined, at 412, into a single executable software application. At 414, the application is deployed on a computing device equipped with a camera, such as an AR headset or a smartphone, to serve as the AR system 100.

Suitable software for creating the AR application is readily commercially available. In one non-limiting embodiment, the software is created in C #and using the Unity game development tool. The program code, or parts thereof, may be written in Visual Studio. A Vuforia Model Target Generator (MTG) may be used to generate the object recognition models (including generating the training data from input CAD models). Unity may be used to combine the object recognition models (MTG datasets), rendered CAD models of various phases, and program code, and the combined models, data sets, and program instructions may be converted, e.g., into an XCode application for deployment on an iOS device. Many other software and AR development tools and 3D model-based registration programs may be used. In general, the disclosed approach relies on 3D virtual models of the physical assembly to create the AR-based instructions. Contemporary assembly developers or companies often build 3D computational models or 2D drawings to create instruction booklets, and these models and drawings can be reused herein. Alternatively, the 3D virtual models may be created by surveying (e.g., 3D scanning) the physical assembly.

FIGS. 5A-5D are schematics of example virtual assembly models for four phases in the assembly of an example physical brick model, illustrating the implementation of the above-discussed phase-based object recognition approach. In this example, the physical assembly is a model of the Arc de Triomphe that includes 386 parts (or bricks). The assembly process is divided into five phases. In phase I, ground plane registration is implemented by using a flat surface to anchor the virtual assembly. 3D AR instructions involve representing the step-by-step addition of parts 1 through 104, registered on the anchored surface location. At step 105, the ground plane detection is disabled, and simultaneously, the object recognition model for phase II is enabled and starts tracking the location and orientation of the physical assembly in camera view. In the AR display, the wireframe model of the parts from the previous steps and the rendered model of the part with index number 105 are juxtaposed on top of the image of physical model. This allows the user to handle the model while the 3D AR instructions move along with it. The AR instructions proceed in the same manner through step 128. At step 129, the object recognition model is switched from the model for Phase II to the model for phase III. To ensure a seamless transition, one step before the switching step (at step 128), the dataset belonging to the next phase (phase III) may be activated. At step 165, another switch takes place from the model of phase III to the model of phase IV. At step 226, the model switches from phase IV to phase V. FIGS. 5A-5D show the virtual assembly models on which the object recognition models for each of phases II-V are trained. These models were devised through experiments to optimize the assembly order in view of several different factors affecting object recognition (distinct edges and orientation), structural stability, and user experience. The virtual assembly models were “diagrammatically” colored for each phase (as indicated in the figures by different fill patterns). Diagrammatic coloring—which does not comport with the realistic appearance of the physical model—can be automatically assigned (e.g., by the MTG) to enhance model tracking performance and robustness. Colors are assigned to the models for each phase individually.

FIG. 6 is a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a smartphone, an AR headset, a web appliance, a network router, switch or bridge, a server computer, a database, conference room equipment, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations. In various embodiments, machine(s) 600 may implement the system of FIG. 1 and/or perform one or both of the processes described above with respect to FIGS. 3 and 4.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, inertial measurement unit (IMU), or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine-readable medium 622 on which are stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine-readable media.

While the machine-readable medium 622 is illustrated as a single medium, the term “machine-readable medium” may include a single medium or multiple media (e.g., a centralized or distributed database, and/or associated caches and servers) configured to store the one or more instructions 624.

The term “machine-readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine-readable media may include non-transitory machine readable media. In some examples, machine-readable media may include machine-readable media that are not a transitory propagating signal.

The instructions 624 may further be transmitted or received over a communications network 626 using a transmission medium via the network interface device 620. The machine 600 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The following numbered examples are illustrative embodiments.

1. A method for providing augmented-reality (AR) instructions for assembly of a physical object, the method being based on an assembly sequence divided into multiple assembly phases containing associated groups of steps, the method comprising: providing, for each of the multiple assembly phases, an associated computational three-dimensional (3D) registration model; and guiding a user step by step through at least a portion of the assembly sequence by performing certain operations. The operation include, for each step within the portion: acquiring a camera image of the physical object in a partially assembled state; using the 3D registration model associated with the assembly phase containing the step to determine a location and orientation of the physical object in the partially assembled state within the camera image; creating an AR image by rendering, overlaid onto the camera image, a virtual model of a part of the physical object to be added during the step, spatially registered with the physical object in the partially assembled state; and displaying the AR image on a display device.

2. The method of example 1, wherein the portion of the assembly sequence comprises a transition between two successive assembly phases, the method comprising switching the registration model from a registration model associated with a first one of the two successive assembly phase to a second one of the two successive assembly phases.

3. The method of example 1 or example 2, maintaining a step counter that is incremented, for each step, responsive to input indicating completion of the step.

4. The method of example 3, wherein the input indication completion of the step is received from the user via a user input device.

5. The method of example 4, wherein the step counter is decremented in response to input, received at any step, indicating reversal of the step.

6. The method of any of examples 1-5, wherein the registration models comprise one or more machine-learned object recognition models each associated with one of the multiple assembly phases and trained on image corresponding to perspective views of the physical object in a partially assembled state associated with one or more steps contained in the respective assembly phase, each image paired with a label indicating a ground-truth location and orientation of the physical object in the perspective view.

7. The method of example 6, wherein the images of the physical object in the partially assembled state are computed from a digital virtual model of the physical object in the partially assembled state.

8. The method of example 7, wherein computing the images from the digital virtual model comprises computationally rotating the digital virtual model to multiple different angles.

9. The method of example 6 or example 7, wherein the registration models further comprise a machine-learned ground plane detection model associated with an initial assembly phase.

10. The method of any of examples 6-9, wherein the multiple assembly phases are defined at least in part based on their impact on an accuracy of the associated registration models.

11. The method of example 10, wherein the multiple assembly phases are defined further based on their impact on at least one of user experience in the assembly of the physical object guided by the AR instructions, or structural stability of the physical object in partially assembled states during the assembly.

12. The method of any of examples 6-11, wherein the one or more machine-learned object recognition models are trained on images of the physical object in a partially assembled state having asymmetric features.

13. The method of any of examples 1-12, wherein creating the AR image further comprises rendering, overlaid onto the camera image, a wireframe model of the physical object in the partially assembled state.

14. The method of any of examples 1-13, wherein creating the AR image further comprises rendering, overlaid onto the camera image, a transparent occlusion model of the physical model in the partially assembled state to represent occlusion of a virtual part by the physical object.

15. A system for providing augmented-reality (AR) instructions for assembly of a physical object based on an assembly sequence divided into multiple assembly phases containing associated groups of steps. The system includes: a camera for acquiring camera images of the physical object during the assembly; a display device for displaying AR images; one or more hardware processors; and one or more machine-readable media. The one or more machine-readable media store: for each of the multiple assembly phases, an associated computational three-dimensional (3D) registration model; and machine-readable instructions which, when executed by the one or more hardware processors, cause the one or more hardware processor to perform operations for guiding a user step by step through at least a portion of the assembly sequence. The operations include, for each step within the portion: acquiring a camera image of the physical object in a partially assembled state from the camera; using the 3D registration model associated with the assembly phase containing the step to determine a location and orientation of the physical object in the partially assembled state within the camera image; and creating an AR image for display on the display device by rendering, overlaid onto the camera image, a virtual model of a part of the physical object to be added during the step, spatially registered with the physical object in the partially assembled state.

16. The system of example 15, wherein the camera, display device, one or more hardware processors, and one or more machine-readable media are integrated into a single physical device.

17. The system of example 16, wherein the single physical device is a smartphone.

18. The system of example 16, wherein the single physical device is an AR headset.

19. The system of any of examples 15-18, configured to implement the method of any of claims 1-14.

20. A machine-readable medium storing machine-readable instructions which, when executed by one or more hardware processors, implement the method of any of claims 1-14.

21. A method for providing augmented reality (AR) instructions for assembly of a physical object. The method comprises providing, for each of multiple assembly phases each including one or more steps, an associated computational three-dimensional (3D) registration model; and guiding a user, based on a step counter, step by step through at least a portion of the assembly. Guiding the user through the portion of the assembly involves performing operations comprising, for each step within the portion: acquiring a camera image of the physical object in a partially assembled state; using the 3D registration model associated with the assembly phase including the step to determine a location and orientation of the physical object in the partially assembled state within the camera image; creating an AR image by rendering, overlaid onto the camera image, a virtual model of a part of the physical object to be added during the step, spatially registered with the physical object in the partially assembled state; displaying the AR image on a display device; and incrementing the step counter responsive to input indicating completion of the step.

22. A method for providing augmented-reality (AR) instructions for disassembly of a physical object, the method being based on an assembly sequence divided into multiple assembly phases containing associated groups of steps, the method comprising: providing, for each of the multiple assembly phases, an associated computational three-dimensional (3D) registration model; and guiding a user step by step through at least a portion of the assembly sequence in reverse order. Guiding the user through the portion of the assembly sequence in reverse order comprises, for each step within the portion: acquiring a camera image of the physical object in a partially assembled state; using the 3D registration model associated with the assembly phase containing the step to determine a location and orientation of the physical object in the partially assembled state within the camera image; creating an AR image by rendering, overlaid onto the camera image, a virtual model of a part of the physical object to be removed during the step for the disassembly, spatially registered with the physical object in the partially assembled state; displaying the AR image on a display device; and decrementing a step counter in response to input indicating completion of the step.

23. The method of example 22, wherein the portion of the assembly sequence comprises a transition between two successive assembly phases, the method comprising switching the registration model, during the disassembly, from a registration model associated with a later one of the two successive assembly phase to an earlier one of the two successive assembly phases in the assembly sequence.

24. The method of any of examples 1-14 or 21-23, wherein the user is a human user.

25. The method of any of examples 1-14 or 21-23, wherein the user is a robot with computer vision.

Although embodiments have been described with reference to specific example embodiments, it will be evident that various modifications and changes may be made to these embodiments without departing from the broader scope of the invention. Accordingly, the specification and drawings are to be regarded in an illustrative rather than a restrictive sense.

What is claimed is:

1. A method for providing augmented reality (AR) instructions for assembly of a physical object, the method being based on an assembly sequence divided into multiple assembly phases containing associated groups of steps, the method comprising:
providing, for each of the multiple assembly phases, an associated computational three-dimensional (3D) registration model; and
guiding a user step by step through at least a portion of the assembly sequence by performing operations comprising, for each step within the portion:
acquiring a camera image of the physical object in a partially assembled state;
using the 3D registration model associated with the assembly phase containing the step to determine a location and orientation of the physical object in the partially assembled state within the camera image;
creating an AR image by rendering, overlaid onto the camera image, a virtual model of a part of the physical object to be added during the step, spatially registered with the physical object in the partially assembled state; and
displaying the AR image on a display device.

2. The method of claim 1, wherein the portion of the assembly sequence comprises a transition between two successive assembly phases, the method comprising switching the registration model from a registration model associated with a first one of the two successive assembly phase to a second one of the two successive assembly phases.

3. The method of claim 1, maintaining a step counter that is incremented, for each step, responsive to input indicating completion of the step.

4. The method of claim 3, wherein the input indication completion of the step is received from the user via a user input device.

5. The method of claim 4, wherein the step counter is decremented in response to input, received at any step, indicating reversal of the step.

6. The method of claim 1, wherein the registration models comprise one or more machine-learned object recognition models each associated with one of the multiple assembly phases and trained on image corresponding to perspective views of the physical object in a partially assembled state associated with one or more steps contained in the respective assembly phase, each image paired with a label indicating a ground-truth location and orientation of the physical object in the perspective view.

7. The method of claim 6, wherein the images of the physical object in the partially assembled state are computed from a digital virtual model of the physical object in the partially assembled state.

8. The method of claim 7, wherein computing the images from the digital virtual model comprises computationally rotating the digital virtual model to multiple different angles.

9. The method of claim 6, wherein the registration models further comprise a machine-learned ground plane detection model associated with an initial assembly phase.

10. The method of claim 6, wherein the multiple assembly phases are defined at least in part based on their impact on an accuracy of the associated registration models.

11. The method of claim 10, wherein the multiple assembly phases are defined further based on their impact on at least one of user experience in the assembly of the physical object guided by the AR instructions, or structural stability of the physical object in partially assembled states during the assembly.

12. The method of claim 6, wherein the one or more machine-learned object recognition models are trained on images of the physical object in a partially assembled state having asymmetric features.

13. The method of claim 1, wherein creating the AR image further comprises rendering, overlaid onto the camera image, a wireframe model of the physical object in the partially assembled state.

14. The method of claim 1, wherein creating the AR image further comprises rendering, overlaid onto the camera image, a transparent occlusion model of the physical model in the partially assembled state to represent occlusion of a virtual part by the physical object.

15. A system to provide augmented-reality (AR) instructions for assembly of a physical object based on an assembly sequence divided into multiple assembly phases containing associated groups of steps, the system comprising:
a camera to acquire camera images of the physical object during the assembly;
a display device to display AR images;
one or more hardware processors; and
one or more machine-readable media storing:
for each of the multiple assembly phases, an associated computational three-dimensional (3D) registration model; and
machine-readable instructions which, when executed by the one or more hardware processors, cause the one or more hardware processor to perform operations for guiding a user step by step through at least a portion of the assembly sequence, the operations comprising, for each step within the portion:
acquiring a camera image of the physical object in a partially assembled state from the camera;
using the 3D registration model associated with the assembly phase containing the step to determine a location and orientation of the physical object in the partially assembled state within the camera image; and
creating an AR image for display on the display device by rendering, overlaid onto the camera image, a virtual model of a part of the physical object to be added during the step, spatially registered with the physical object in the partially assembled state.

16. The system of claim 15, wherein the camera, display device, one or more hardware processors, and one or more machine-readable media are integrated into a single physical device.

17. The system of claim 16, wherein the single physical device is a smartphone.

18. The system of claim 16, wherein the single physical device is an AR headset.

19. The system of claim 15, the operations further comprising maintaining a step counter that is incremented, for each step, responsive to input indicating completion of the step.

20. A machine-readable medium storing machine-readable instructions which, when executed by one or more hardware processors, cause the one or more hardware processors to perform operations for providing augmented-reality (AR) instructions for assembly of a physical object based on an assembly sequence divided into multiple assembly phases containing associated groups of steps, the operations comprising:
providing, for each of the multiple assembly phases, an associated computational three-dimensional (3D) registration model; and
guiding a user step by step through at least a portion of the assembly sequence by performing operations comprising, for each step within the portion:
acquiring a camera image of the physical object in a partially assembled state;
using the 3D registration model associated with the assembly phase containing the step to determine a location and orientation of the physical object in the partially assembled state within the camera image;
creating an AR image by rendering, overlaid onto the camera image, a virtual model of a part of the physical object to be added during the step, spatially registered with the physical object in the partially assembled state; and
displaying the AR image on a display device.
